(19) United States
(12) Patent Application Publication
(10) Pub. No.: US 2025/0374193 A1
(43) Pub. Date: Dec. 4, 2025

(54) SIGNAL SENDING METHOD, SIGNAL RECEIVING METHOD, AND APPARATUS, TERMINAL AND NETWORK-SIDE DEVICE

(71) Applicant: VIVO MOBILE COMMUNICATION CO., LTD., Dongguan (CN)

(72) Inventors: Dajie JIANG, Dongguan (CN); Wei HUANG, Dongguan (CN); Rongling JIAN, Dongguan (CN)

(21) Appl. No.: 19/298,232

(22) Filed: Aug. 13, 2025

Related U.S. Application Data
(63) Continuation of application No. PCT/CN2024/076498, filed on Feb. 7, 2024.

(30) Foreign Application Priority Data
Feb. 14, 2023 (CN) 202310112725.9

(51) Int. Cl. H04W 52/02

(52) U.S. Cl. CPC H04W 52/0235; H04W 52/0203

(57) ABSTRACT

Provided are a signal sending method and apparatus, a signal receiving method and apparatus, a terminal, and a network side device. The signal sending method includes: a terminal sends a first signal to a first network side device through an ultra-low power module, where the first signal is used for at least one of the following: indicating to enable a main communication module, and indicating to enter a target communication mode; the ultra-low power module supports ultra-low power communication; the target communication mode includes one of the following: a first mode, a second mode, a third mode, and a fourth mode; and power consumption levels of the first mode, the second mode, the third mode, and the fourth mode decreases successively.

### CROSS-REFERENCE TO RELATED APPLICATIONS

This application is a continuation of International Patent Application No. PCT/CN2024/076498, filed on Feb. 7, 2024, which claims priority to Chinese Patent Application No. 202310112725.9, filed in China on Feb. 14, 2023, both of which are incorporated herein by reference in their entireties.

### TECHNICAL FIELD

This application pertains to the field of communication technologies, and specifically relates to a signal sending method and apparatus, a signal receiving method and apparatus, a terminal, and a network side device.

### BACKGROUND

In some related technologies, an ultra-low power communication technology (for example, a backscatter technology) is used as a key technology of passive internet of things devices.

### SUMMARY

Embodiments of this application provide a signal sending method and apparatus, a signal receiving method and apparatus, a terminal, and a network side device.

According to a first aspect, a signal sending method is provided. The method includes:

A terminal sends a first signal to a first network side device through an ultra-low power module, where the first signal is used for at least one of the following: indicating to enable a main communication module, and indicating to enter a target communication mode;
the ultra-low power module is a module that supports ultra-low power communication;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

According to a second aspect, a signal receiving method is provided. The method

includes:

A first network side device receives a first signal sent by a terminal, where the first signal is used for at least one of the following: indicating to enable a main communication module, and indicating to enter a target communication mode;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

According to a third aspect, a signal sending apparatus is provided. The apparatus includes:
a sending module, configured to send a first signal to a first network side device through an ultra-low power module, where the first signal is used for at least one of the following: indicating to enable a main communication module, and indicating to enter a target communication mode;
the ultra-low power module is a module that supports ultra-low power communication;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

According to a fourth aspect, a signal receiving apparatus is provided. The apparatus includes:
a first receiving module, configured to receive a first signal sent by a terminal, where the first signal is used for at least one of the following: indicating to enable a main communication module, and indicating to enter a target communication mode;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

According to a fifth aspect, a terminal is provided. The terminal includes a processor and a memory, and the memory stores a program or an instruction that can be run on the processor; and when the program or the instruction is executed by the processor, steps of the signal sending method according to embodiments of this application are implemented.

According to a sixth aspect, a terminal is provided. The terminal includes a processor and a communication interface. The communication interface is configured to send a first signal to a first network side device through an ultra-low power module, where the first signal is used for at least one of the following: indicating to enable a main communication module, and indicating to enter a target communication mode; the ultra-low power module is a module that supports ultra-low power communication; the target communication mode includes one of the following: a first mode, a second mode, a third mode, and a fourth mode; and a power consumption level of the first mode is higher than a power consumption level of the second mode, the power consumption level of the second mode is higher than a power consumption level of the third mode, and the power consumption level of the third mode is higher than a power consumption level of the fourth mode.

According to a seventh aspect, a network side device is provided. The network side device includes a processor and a memory, and the memory stores a program or an instruction that can be run on the processor; and when the program or the instruction is executed by the processor, steps of the signal receiving method according to embodiments of this application are implemented.

According to an eighth aspect, a network side device is provided. The network side device includes a processor and a communication interface. The processor is configured to send a first signal, and the communication interface is configured to receive the first signal sent by the processor, where the first signal is used for at least one of the following: indicating to enable a main communication module, and indicating to enter a target communication mode; the target communication mode includes one of the following: a first mode, a second mode, a third mode, and a fourth mode; and a power consumption level of the first mode is higher than a power consumption level of the second mode, the power consumption level of the second mode is higher than a power consumption level of the third mode, and the power consumption level of the third mode is higher than a power consumption level of the fourth mode.

According to a ninth aspect, a signal transmission system is provided. The signal transmission system includes a terminal and a network side device. The terminal may be configured to perform steps of the signal sending method according to embodiments of this application, and the network side device may be configured to perform steps of the signal receiving method according to embodiments of this application.

According to a tenth aspect, a readable storage medium is provided. The readable storage medium stores a program or an instruction; and when the program or the instruction is executed by a processor, steps of the signal sending method according to embodiments of this application are implemented, or steps of the signal receiving method according to embodiments of this application are implemented.

According to an eleventh aspect, a chip is provided. The chip includes a processor and a communication interface. The communication interface is coupled to the processor, and the processor is configured to run a program or an instruction, to implement the signal sending method according to embodiments of this application, or implement the signal receiving method according to embodiments of this application.

According to a twelfth aspect, a computer program/program product is provided. The computer program/program product is stored in a storage medium, and the computer program/program product is executed by at least one processor to implement steps of the signal sending method according to embodiments of this application, or the computer program/program product is executed by at least one processor to implement steps of the signal receiving method according to embodiments of this application.

### BRIEF DESCRIPTION OF THE DRAWINGS

FIG. 1 is a block diagram of a wireless communication system to which embodiments of this application may be applied;

FIG. 2 is a schematic diagram of a transmission location between a terminal and a network side device according to an embodiment of this application;

FIG. 3 is a schematic diagram of an ultra-low power module according to an embodiment of this application;

FIG. 4 is a flowchart of a signal sending method according to an embodiment of this application;

FIG. 5 is a flowchart of a signal receiving method according to an embodiment of this application;

FIG. 6 is a structural diagram of a signal sending apparatus according to an embodiment of this application;

FIG. 7 is a structural diagram of a signal receiving apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network side device according to an embodiment of this application.

### DESCRIPTION OF EMBODIMENTS

The following clearly describes technical solutions in embodiments of this application with reference to the accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this application are used to distinguish between similar objects, instead of describing a specific order or sequence. It should be understood that the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions. To be specific, Solution 1: A is included but B is not included; Solution 2: B is included but A is not included; and Solution 3: both A and B are included. The character “/” usually indicates an “or” relationship between associated objects.

The term “indication” in this application may be either a direct indication (or an explicit indication) or an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in embodiments of this application are not limited to a long term evolution (Long Term Evolution, LTE)/LTE-advanced (LTE-Advanced, LTE-A) system, and may also be used in other wireless communication systems such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency division multiple access (Single-carrier Frequency Division Multiple Access, SC-FDMA) system, or another system. The terms “system” and “network” in embodiments of this application may be used interchangeably. The technologies described can be applied to both the systems and the radio technologies mentioned above as well as to other systems and radio technologies. A new radio (New Radio, NR) system is described in the following descriptions for illustrative purposes, and the NR terminology is used in most of the following descriptions, although these technologies can also be applied to a system other than the NR system, for example, a 6^{th} generation (6^{th} Generation, 6G) communication system.

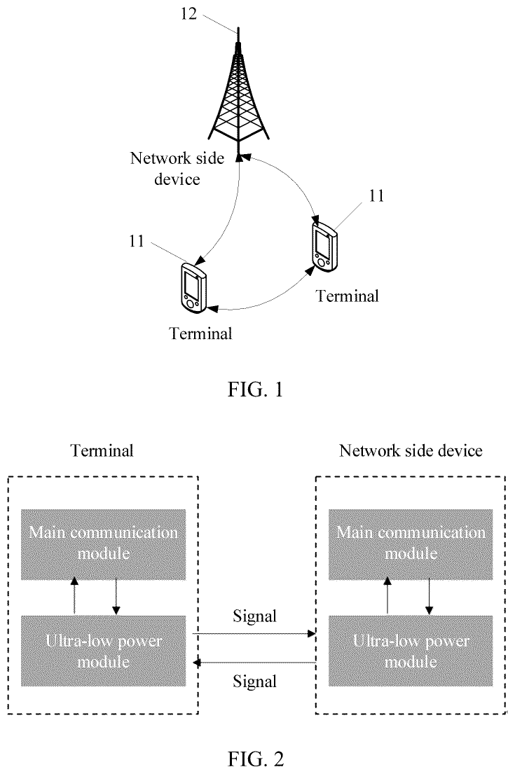

FIG. 1 is a block diagram of a wireless communication system to which embodiments of this application may be applied. The wireless communication system includes a terminal 11 and a network side device 12. The terminal 11 may be a terminal side device, for example, a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), a flight vehicle (flight vehicle), vehicle user equipment (Vehicle User Equipment, VUE), maritime user equipment, pedestrian user equipment (Pedestrian User Equipment, PUE), a smart home (a home device having a wireless communication function, for example, a refrigerator, a television, a washing machine, or furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, or the like), a smart wrist strap, smart clothes, and the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, and the like. The base station may be referred to as a NodeB (NodeB, NB), an evolved NodeB (Evolved NodeB, eNB), a next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the field. Provided that same technical effect is achieved, the base station is not limited to a specified technical term. It should be noted that in embodiments of this application, only a base station in an NR system is used as an example for description, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application server discovery function (Edge Application Server Discovery Function, EASDF), a unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF). It should be noted that in embodiments of this application, only a core network device in an NR system is used as an example for description, and a specific type of the core network device is not limited.

In some embodiments, for the terminal and the network side device, refer to FIG. 2. The terminal includes a main communication module and an ultra-low power module. The network side device includes a main communication module and an ultra-low power module. The main communication module may communicate with the ultra-low power module, and the ultra-low power module of the terminal may communicate with the ultra-low power module of the network side device. It should be noted that FIG. 2 is merely an example for illustration. For example, in some embodiments, the main communication module of the terminal may communicate with the main communication module of the network side device. In some embodiments, the ultra-low power module of the terminal may communicate with the main communication module of the network side device.

In some embodiments, the main communication module may support a communication technology in a conventional communication manner (for example, 4^{th} generation (4^{th} Generation, 4G), 5^{th} generation (5^{th} Generation, 5G), or 6G) oriented to a mobile broadband (Mobile Broadband, MBB) scenario or an enhanced mobile broadband (Enhanced Mobile Broadband, eMBB) scenario. For example, a 5G NR technology that supports orthogonal frequency division multiplex (Orthogonal frequency division multiplex, OFDM) communication includes uplink or downlink communication.

In some embodiments, the ultra-low power module may support ultra-low power communication, and may also support low power receiving. For example, the ultra-low power module includes a low power receiving module such as a low power wakeup receiver, namely, a low power wakeup signal (Low power wakeup signal) of the release 18 that is being discussed in the 3rd generation partnership project (3rd Generation Partnership Project, 3GPP).

In some embodiments, the ultra-low power communication may include at least one of the following:
backscatter communication (Backscatter Communication) supporting energy harvesting;
backscatter communication supporting energy supply; and
low power receiving.

For example, the ultra-low power module may support energy harvesting, including but not limited to energy harvesting from light, solar energy, radio signals, and the like.

In addition, an incident signal of the backscatter communication may be generated by the terminal that has the ultra-low power module or another device.

In some embodiments, the ultra-low power communication may be communication whose power consumption is significantly lower than that of the main communication module. For example, communication of the communication module whose power consumption is generally from dozens of microwatts to hundreds of microwatts is ultra-low power communication; and power consumption of the main communication module is generally from dozens of milliwatts to thousands of milliwatts, and costs of the ultra-low power module are also significantly lower than costs of the main communication module.

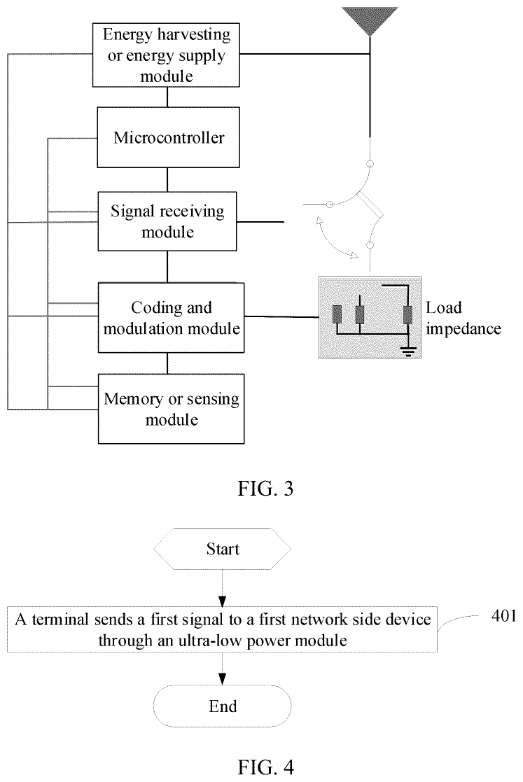

Backscatter communication (Backscatter Communication) is the most representative technology for ultra-low power communication. In principle, a backscatter communication device controls a reflection coefficient of a circuit by adjusting internal impedance of the backscatter communication device, to change an amplitude, a frequency, a phase, and the like of a radio frequency signal from another device or environment, and implement signal modulation. A typical hardware module for the backscatter communication may be shown in FIG. 3, and includes: an antenna unit, an energy harvesting module or an energy supply module, a microcontroller, a signal receiving module, a channel coding and modulation module, a memory, a sensing module, or the like. The signal receiving module is responsible for receiving a downlink signal sent by a network side device, a card reader, or the like to a backscatter device. An architecture and a technology of the signal receiving module may reuse a low power wakeup receiver technology protocol-defined or newly defined subsequently. Because the backscatter communication does not actively generate a radio frequency signal, energy consumption of the backscatter communication is ultra-low, and is usually from dozens of microwatts to hundreds of microwatts, and modulation, demodulation, and reflection of an energy supply signal such as a radio frequency signal, light energy, and heat energy in an environment may be harvested by the energy harvesting module, without having an energy source such as a battery; or may be supplied by a small energy supply module such as a button battery, to reduce a strength requirement on the energy supply signal. In addition to the foregoing typical constituent modules, the backscatter communication technology may integrate a low power amplifier module, configured to improve receiving sensitivity and a backscatter signal power.

It should be noted that in embodiments of this application, the backscatter communication is merely an example of ultra-low power communication. In embodiments of this application, the ultra-low power communication is not limited, for example, may be protocol-defined ultra-low power communication, or may be communication of the communication module whose power consumption is from dozens of microwatts to hundreds of microwatts.

With reference to the accompanying drawings, the following describes in detail, by using some embodiments and application scenarios of the embodiments of this application, a signal sending method and apparatus, a signal receiving method and apparatus, a terminal, and a network side device provided in embodiments of this application.

FIG. 4 is a flowchart of a signal sending method according to an embodiment of this application. As shown in FIG. 4, the method includes the following steps.

Step 401: A terminal sends a first signal to a first network side device through an ultra-low power module, where the first signal is used for at least one of the following: indicating to enable a main communication module, and indicating to enter a target communication mode;
the ultra-low power module is a module that supports ultra-low power communication;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Sending the first signal may be actively triggered by the terminal. For example, the terminal sends the first signal to the first network side device based on a state, a service requirement, or the like of the terminal.

Indicating to enable the main communication module may be indicating one or more network side devices to enable the main communication module, for example, indicating the first network side device to enable the main communication module, or indicating a second network side device to enable the main communication module.

In addition, enabling a state of the main communication module may include:
enabling the state of the main communication module, and disabling the ultra-low power module; or
enabling the state of the main communication module, and enabling the ultra-low power module.

Indicating to enter the target communication mode may be indicating the one or more network side devices to enter the target communication mode, for example, indicating the first network side device to enter the target communication mode, or indicating the second network side device to enter the target communication mode.

The first mode, the second mode, the third mode, and the fourth mode may be predefined modes supported by the network side device, and these communication modes may be protocol-agreed or obtained through division by the network side device. For example, the first mode is a high power consumption level mode, the second mode is a medium power consumption level mode, the third mode is a low power consumption level mode, and the fourth mode is an ultra-low power consumption level mode.

In some implementations, indicating to enable the main communication module may also be requesting the network side device to enable the main communication module, and indicating to enter the target communication mode may also be requesting the network side device to enter the target communication mode.

In this embodiment of this application, the terminal sends, to the network side device through the ultra-low power module, the first signal that is used for at least one of the following: indicating to enable the main communication module, and indicating to enter the target communication mode, so that the terminal can support ultra-low power communication, the network side device can flexibly enable the main communication module or switch the communication mode, and power consumption of the terminal and the network side device can be saved.

In addition, the terminal may indicate the network side device to enable the main communication module, so that the network side device can respond to the terminal to enable the main communication module, the terminal can communicate with the main communication module of the network side device, and transmission performance of the terminal can be improved. In addition, the terminal may indicate the network side device to enter the target communication mode, so that the network side device can respond to the terminal to enter the target communication mode, the communication mode of the network side device can better match the terminal, and transmission performance of the terminal can be improved.

In an optional implementation, the ultra-low power communication includes at least one of the following:
backscatter communication and low power receiving.

The backscatter communication may include at least one of the following:
backscatter communication (Backscatter Communication) supporting energy harvesting; and
backscatter communication supporting energy supply.

The low power receiving may be low power receiving module communication, for example, low power wakeup receiver communication.

In this implementation, the ultra-low power module may support ultra-low power communication, backscatter communication, and low power receiving, to save power consumption of the terminal. For example, the ultra-low power module supports at least one of a backscatter communication module and a low power receiving model (for example, a low power wakeup receiver).

In an optional implementation, the ultra-low power module also supports energy harvesting.

For example, the ultra-low power module may also support energy harvesting, for example, energy harvesting from light, solar energy, radio signals, and the like.

The ultra-low power module supports energy harvesting, so that power consumption of the terminal can be further saved.

It should be noted that, in some implementations, the ultra-low power module may also use energy provided by the terminal.

In an optional implementation, power consumption of the main communication module is higher than power consumption of the ultra-low power module.

For example, the ultra-low power communication is communication of the communication module whose power consumption is generally from dozens of microwatts to hundreds of microwatts; and power consumption of the main communication module is generally from dozens of milliwatts to thousands of milliwatts, and costs of the ultra-low power module are also significantly lower than costs of the main communication module.

In an optional implementation, the indicating to enable a main communication module includes:
indicating to enable the main communication module of a first frequency.

The first frequency may be a frequency determined by the terminal, for example, a frequency corresponding to a service of the terminal, or a frequency corresponding to an operating bandwidth of the terminal.

In this way, the network side device is indicated to enable the main communication module of the first frequency, and a main communication module of another frequency may not be enabled, so that power consumption of the network side device can be saved.

It should be noted that in some implementations, the frequency may not be indicated. For example, the network side device considers by default that the terminal indicates to enable the main communication module of the frequency corresponding to the terminal, or the network side device enables main communication modules of a plurality of frequencies or all frequencies.

In an optional implementation, the first signal is used for at least one of the following:
indicating the first network side device to enable the main communication module; and
indicating at least one second network side device to enable the main communication module.

In this implementation, the terminal may flexibly indicate one or more network side devices to enable the main communication module, to help improve transmission performance of the terminal. For example, the ultra-low power module of the terminal is in coverage of the first network side device, and the main communication module is in coverage of the second network side device. In this way, the main communication module of the second network side device may be indicated to be enabled, and the main communication module communicates with the main communication module of the second network side device, to improve transmission performance of the terminal.

Optionally, the indicating at least one second network side device to enable the main communication module includes:
indicating the at least one second network side device to enable the main communication module of a second frequency.

The second frequency may be a frequency determined by the terminal, for example, a frequency corresponding to a service of the terminal, or a frequency corresponding to an operating bandwidth of the terminal.

In this way, the second network side device is indicated to enable the main communication module of the second frequency, and a main communication module of another frequency may not be enabled, so that power consumption of the second network side device can be saved.

In addition, the first network side device may also be indicated to enable a main communication module of a specific frequency.

Optionally, in a case that the first signal indicates the at least one second network side device to enable the main communication module, the first signal includes: identification information of the at least one second network side device.

The identification information may include at least one of the following:
a cell identifier (cell ID), a TRP ID, an AP ID, or the like.

The identification information may simply and directly indicate the at least one second network side device.

It should be noted that in some implementations, the identification information of the second network side device may not be carried. For example, the first network side device considers by default that a network side device of a neighboring cell of a current serving cell of the terminal is the second network side device.

In an optional implementation, after that a terminal sends a first signal to a first network side device through an ultra-low power module, the method further includes:

The terminal performs a target operation, where the target operation includes at least one of the following:
measuring a second signal sent by the first network side device;
measuring a second signal sent by the second network side device;
receiving a third signal sent by the first network side device;
receiving a third signal sent by the second network side device; and
sending a preamble.

The second signal and the third signal may be signals sent by the first network side device or the second network side device after enabling the main communication module or entering the target communication mode, or may be signals sent by the first network side device or the second network side device after receiving the first signal without enabling the main communication module or entering the target communication mode, for example, signals sent by the ultra-low power module.

In addition, the terminal may perform the target operation through the ultra-low power module or the main communication module.

In the foregoing implementation, after the first signal is sent, the second signal and the third signal may be measured or received, and this helps the terminal improve service performance of the terminal.

Optionally, the second signal includes: a reference signal.

Optionally, the third signal includes at least one of the following:
a synchronization signal, system information, or a paging signal.

The synchronization signal may be a synchronization signal block (Synchronization Signal Block, SSB), and the system information may be a system information block (System Information Block, SIB).

After the first signal is sent, the reference signal, the synchronization signal, the system information, or the paging signal may be measured or received, and this helps the terminal improve service performance of the terminal.

It should be noted that in some implementations, before sending the first signal, the terminal may also measure or receive the second signal or the third signal.

Optionally, that the terminal performs a target operation includes:

The terminal performs the target operation at a first time through the main communication module, where an interval between the first time and a sending time of the first signal is greater than or equal to first preset duration; or
the terminal performs the target operation at a second time through the ultra-low power module, where an interval between the second time and a sending time of the first signal is greater than or equal to second preset duration.

In this implementation, after the first signal is sent, the main communication module may be enabled or disabled. In this way, the main communication module or the ultra-low power module may be flexibly used to communicate with a network side, and this helps save power consumption of the terminal.

It should be noted that, in some implementations, the terminal may communicate with the main communication module or the target communication mode of the network side device through the ultra-low power module, or may communicate with the main communication module or the target communication mode of the network side device through the main communication module.

In an optional implementation, an incident signal of the first signal is sent by the first network side device; or
an incident signal of the first signal is sent by the second network side device; or
an incident signal of the first signal is sent by a third-party device; or
an incident signal of the first signal is generated by the terminal.

The third-party device may be a device other than the first network side device, the second network side device, and the terminal.

In this implementation, the incident signal of the first signal sent by the ultra-low power module can be supported to be sent by a plurality of devices. In this way, flexibility of sending the first signal by the ultra-low power module can be improved, and the incident signal of the first signal is sent by the first network side device, the second network side device, and the third-party device, so that power consumption of the terminal can be saved.

Optionally, that a terminal sends a first signal to a first network side device through an ultra-low power module includes at least one of the following:

In a case that the incident signal of the first signal is sent by the first network side device, the second network side device, or the third-party device, the terminal sends the first signal in a sending window of the incident signal through the ultra-low power module; or
in a case that the incident signal of the first signal is generated by the terminal, the terminal sends the first signal at a random moment or in a preset window through the ultra-low power module; or
in a case that the sending time of the first signal exceeds one sending window of the corresponding incident signal, the terminal jointly sends the first signal in a plurality of sending windows of the incident signal through the ultra-low power module, where the sending time of the first signal is generated based on the incident signal of the first signal.

The sending window of the incident signal may be notified to the terminal by the network side device or protocol-agreed. The preset window may be protocol-agreed or preconfigured by the terminal.

Sending the first signal in the sending window of the incident signal through the ultra-low power module may be sending the first signal in a continuous or discontinuous sending window of the incident signal through the ultra-low power module.

That the sending time of the first signal exceeds one sending window of the corresponding incident signal may be that the sending time of the first signal is greater than duration of one sending window of the incident signal.

Jointly sending the first signal in the plurality of sending windows of the incident signal through the ultra-low power module may be jointly sending the first signal in a plurality of discontinuous sending windows.

In the foregoing implementation, the first signal can be flexibly sent in different scenarios, and transmission reliability of the first signal can also be improved by jointly sending the first signal in the plurality of sending windows.

In an optional implementation, a transmit power of the first signal sent by the terminal includes:
a fixed power; or
a transmit power determined based on a parameter of a downlink signal detected by the terminal.

The parameter may include at least one of the following:
a reference signal received power (Reference Signal Received Power, RSRP), a signal to interference plus noise ratio (signal to interference plus noise ratio, SINR), and a signal-to-noise ratio (Signal-to-noise ratio, SNR).

The fixed power may be notified to the terminal by the network side device or protocol-agreed.

The transmit power determined based on the parameter of the downlink signal detected by the terminal may include:
a transmit power determined based on the RSRP of the downlink signal detected by the terminal and a preset formula; or
a transmit power determined based on the SINR of the downlink signal detected by the terminal and a preset SINR; or
a transmit power determined based on the SNR of the downlink signal detected by the terminal and a preset SNR.

The preset formula may be notified to the terminal by the network side device or protocol-agreed. For example, the preset formula may be an NR uplink power control formula similar to that protocol-agreed. A parameter associated with the preset formula may include PO, a compensation factor (alpha), and the like. This is not specifically limited herein.

The preset SINR and the preset SNR may be notified to the terminal by the network side device or protocol-agreed. Determining the transmit power based on an SINR/SNR value of the downlink signal detected by the terminal may be determining the transmit power through comparison between an SINR/SNR value of the reference signal and a preset SINR/SNR value.

The downlink signal may include at least one of the following:
a downlink reference signal and a synchronization signal.

The downlink reference signal and the synchronization signal may be sent by the network side device through the ultra-low power module.

In the foregoing implementation, the fixed power may reduce complexity of sending the first signal, and the transmit power determined based on the parameter of the downlink signal detected by the terminal can make transmission power consumption of the first signal sent by the terminal match the parameter of the downlink signal. This helps improve transmission reliability of the first signal.

In an optional implementation, before that a terminal sends a first signal to a first network side device through an ultra-low power module, the method further includes:

The terminal determines parameter configuration information of the first signal according to a protocol specification; or
the terminal determines parameter configuration information of the first signal based on configuration information sent by a network side, where
the parameter configuration information may include at least one of the following:
a time resource, a frequency resource, a signal waveform, a modulation scheme, a coding scheme, a sequence generation parameter, a reflection coefficient, and a transmit power.

In a case that the parameter configuration information is determined based on the configuration information sent by the network side, one part of the parameter configuration information may be configured by the network side, and the other part of the parameter configuration information may be protocol-agreed or configured by the terminal; or the parameter configuration information is configured by the network side. This is not limited thereto.

In this implementation, the parameter configuration information of the first signal may be determined in the foregoing two manners, and the first signal can be better transmitted between the terminal and the network side device, to improve transmission reliability of the first signal.

Optionally, the sequence generation parameter is associated with identification information of the first network side device.

That the sequence generation parameter is associated with the identification information of the first network side device may be that the sequence generation parameter has an association relationship protocol-agreed or configured by the network side with the identification information of the first network side device. In this way, the network side device of the sequence generation parameter may determine that the first signal is sent to the first network side device, to reduce overheads of the first signal.

In an optional implementation, the first signal is used for at least one of the following:
indicating the first network side device to enter the target communication mode; and
indicating the at least one second network side device to enter the target communication mode.

In this implementation, the terminal can flexibly indicate one or more network side devices to enter the target communication mode, and this helps improve transmission performance of the terminal.

In addition, the first network side device and the at least one second network side device may also be indicated to enter the target communication mode at a specific frequency, to save power consumption of the network side device.

Optionally, in a case that the first signal indicates the at least one second network side device to enter the target communication mode, the first signal includes: identification information of the at least one second network side device.

The identification information may include at least one of the following:
a cell identifier (cell ID), a TRP ID, an AP ID, or the like.

The identification information may simply and directly indicate the at least one second network side device.

It should be noted that in some implementations, the identification information of the second network side device may be carried. For example, the first network side device considers by default that a network side device of a neighboring cell of a current serving cell of the terminal is the second network side device.

In an optional implementation, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

The synchronization signal may be an SSB.

In this implementation, quantities of transmit channels, quantities of receive channels, and quantities of synchronization signal blocks in different modes may be different, to support the network side device to enter different modes based on an actual requirement, and save power consumption of the network side device.

In an optional implementation, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module.

An implementation is shown in Table 1:

TABLE 1
Different modes of the network side device

| | | | | | Whether |
|---|---|---|---|---|---|
| | | | | | to enable |
| | | Quantity | Quantity | | the main |
| Different | Power | of | of | | communi- |
| target | consumption | transmit | receive | Quantity | cation |
| modes | level | channels | channels | of SSBs | module |
| First | High | 64 | 64 | 16 | Yes |
| mode | | | | | |
| Second | Medium | 8 | 8 | 8 | Yes |
| mode | | | | | |
| Third | Low | 2 | 2 | 4 | Yes |
| mode | | | | | |
| Fourth | Ultra-low | 1 | 1 | 1 | No |
| mode | | | | | |

Another implementation is shown in Table 2:

TABLE 2

| | | | | | Whether to | Whether to |
|---|---|---|---|---|---|---|
| Support- | Power | Quantity | Quantity | | enable the | enable the |
| ed | con- | of | of | | main com- | ultra-low |
| target | sumption | transmit | receive | Quantity | munication | power |
| modes | level | channels | channels | of SSBs | module | module |
| First | High | 64 | 64 | 16 | Yes | Yes/No |
| mode | | | | | | |
| Second | Medium | 8 | 8 | 8 | Yes | Yes/No |
| mode | | | | | | |
| Third | Low | 2 | 2 | 4 | Yes | Yes/No |
| mode | | | | | | |
| Fourth | Ultra-low | 1 | 1 | 1 | No | Yes |
| mode | | | | | | |

In the foregoing implementation, the ultra-low power module may be enabled or disabled in some modes, and the main communication module may be enabled or disabled in some modes, to support the network side device to enter different modes based on an actual requirement, and save power consumption of the network side device.

In this embodiment of this application, the terminal sends the first signal to the first network side device through the ultra-low power module, where the first signal is used for at least one of the following: indicating to enable the main communication module, and indicating to enter the target communication mode; the ultra-low power module is the module that supports ultra-low power communication; the target communication mode includes one of the following: the first mode, the second mode, the third mode, and the fourth mode; and the power consumption level of the first mode is higher than the power consumption level of the second mode, the power consumption level of the second mode is higher than the power consumption level of the third mode, and the power consumption level of the third mode is higher than the power consumption level of the fourth mode. In this way, the terminal can send, to the network side device through the ultra-low power module, the first signal that is used for at least one of the following: indicating to enable the main communication module, and indicating to enter the target communication mode, so that the terminal can support ultra-low power communication, the network side device can flexibly enable the main communication module or switch the communication mode, and power consumption of the terminal and the network side device can be saved.

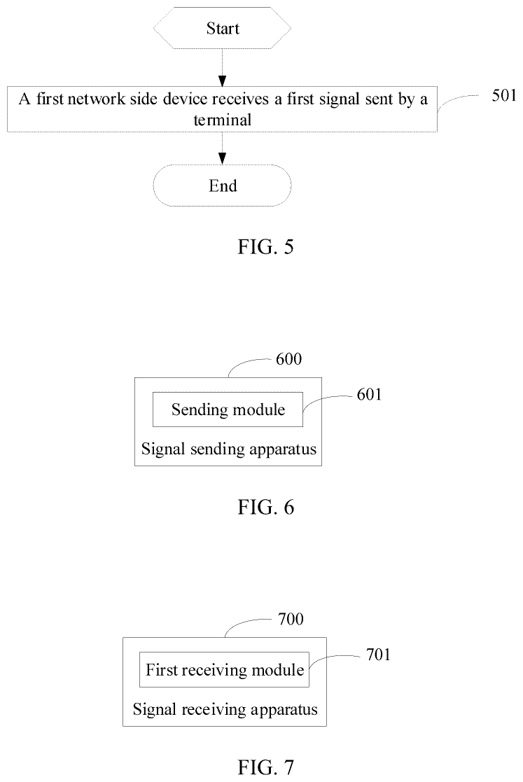

FIG. 5 is a flowchart of another signal sending method according to an embodiment of this application. As shown in FIG. 5, the method includes the following steps.

Step 501: A first network side device receives a first signal sent by a terminal, where the first signal is used for at least one of the following: indicating to enable a main communication module, and indicating to enter a target communication mode;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Optionally, the method further includes:

The first network side device performs a target operation based on the first signal, where the target operation includes at least one of the following: enabling the main communication module, and entering the target communication mode.

It should be noted that, in some implementations, the first network side device may choose not to perform the target operation after receiving the first signal, for example, send a reference signal, a synchronization signal, or the like through an ultra-low power module, to allow the terminal to perform measurement.

Optionally, the indicating to enable a main communication module includes:
indicating to enable the main communication module of a first frequency.

Optionally, the first signal is used for at least one of the following:
indicating the first network side device to enable the main communication module; and
indicating at least one second network side device to enable the main communication module; and
in a case that the first signal indicates the at least one second network side device to enable the main communication module, the method further includes:
the first network side device sends indication information of the first signal to the at least one network side device, where the indication information is used to indicate the at least one second network side device to enable the main communication module.

Optionally, the indicating at least one second network side device to enable the main communication module includes:
indicating the at least one second network side device to enable the main communication module of a second frequency.

Optionally, in a case that the first signal indicates the at least one second network side device to enable the main communication module, the first signal includes: identification information of the at least one second network side device.

Optionally, after that a first network side device receives a first signal sent by a terminal, the method further includes at least one of the following:

The first network side sends a second signal to the terminal through the ultra-low power module, where the ultra-low power module is a module that supports ultra-low power communication;
the first network side device sends a third signal to the terminal through the main communication module; and
the first network side device receives a preamble sent by the terminal.

Optionally, the second signal includes: a reference signal; and
the third signal includes at least one of the following:
a synchronization signal, system information, or a paging signal.

Optionally, before that a first network side device receives a first signal sent by a terminal, the method further includes:

The first network side device sends an incident signal of the first signal to the terminal.

Optionally, that a first network side device receives a first signal sent by a terminal includes:

The first network side device receives, in a sending window of the incident signal, the first signal sent by the terminal.

Optionally, before that a first network side device receives a first signal sent by a terminal, the method further includes:

The first network side device sends configuration information to the terminal, where the configuration information is used to determine parameter configuration information of the first signal; and
the parameter configuration information includes at least one of the following:
a time resource, a frequency resource, a signal waveform, a modulation scheme, a coding scheme, a sequence generation parameter, a reflection coefficient, and a transmit power.

Optionally, the sequence generation parameter is associated with identification information of the first network side device.

Optionally, the first signal is used for at least one of the following:
indicating the first network side device to enter the target communication mode; and
indicating the at least one second network side device to enter the target communication mode; and
in a case that the first signal indicates the at least one second network side device to enter the target communication mode, the method further includes:
the first network side device sends indication information of the first signal to the at least one network side device, where the indication information is used to indicate the at least one second network side device to enter the target communication mode.

Optionally, in a case that the first signal indicates the at least one second network side device to enter the target communication mode, the first signal includes: identification information of the at least one second network side device.

Optionally, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

Optionally, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module, where the ultra-low power module is a module that supports ultra-low power communication.

It should be noted that this embodiment is used as an implementation of the network side device corresponding to the embodiment shown in FIG. 4. For a specific implementation of this embodiment, refer to related descriptions of the embodiment shown in FIG. 4. To avoid repetition, details are not described in this embodiment.

The method provided in embodiments of this application is described below by using examples with a plurality of embodiments.

### Embodiment 1

In this embodiment, the terminal indicates, through the ultra-low power module, the network side to enable the main communication module. Beneficial effect of this embodiment includes: When there is no service or a communication rate required by the service is low, the terminal performs communication and measurement through the ultra-low power module and the ultra-low power module of the network side device, which helps the terminal and the network side device save energy. When a service (a high communication rate requirement) arrives, the terminal indicates, through the ultra-low power module, the network side to enable the main communication module, and the terminal also communicates with the main communication module of the network side device through the main communication module, which can meet a service requirement of a high communication rate requirement. Details are as follows:

Step 1: The terminal sends the first signal to the first network side device through the ultra-low power module, where the first signal is used to indicate at least one of the following: (a behavior related to the first network side device).

The first network side device enables the main communication module, so that the first network side device can enable a cell through the main communication module and send a synchronization signal block (Synchronization Signal Block, SSB), a system information block (System Information Block, SIB), and the like.

The first network side device enables the main communication module of a target frequency, so that the first network side device can enable a cell of the target frequency through the main communication module, and send the an SSB, a SIB, and the like.

In addition, the first network side device may send a reference signal through the ultra-low power module (which is used by the terminal for measurement; and in this case, the network side device may not enable the main communication module).

The first network side device may send a reference signal at the target frequency through the ultra-low power module (which is used by the terminal for measurement; and in this case, the network side device may not enable the main communication module).

The first signal may further indicate at least one of the following: (a behavior related to the second network side device).

The at least one second network side device enables the main communication module, so that the second network side device can enable a cell through the main communication module, and send the an SSB, a SIB, and the like.

The at least one second network side device enables the main communication module of a target frequency, so that the second network side device can enable a cell of the target frequency through the main communication module, and send the an SSB, a SIB, and the like.

The at least one second network side device sends the reference signal through the ultra-low power module (which is used by the terminal for measurement; and in this case, the network side device may not enable the main communication module). In this way, the at least one second network side device may send the reference signal at the target frequency through the ultra-low power module (which is used by the terminal for measurement; and in this case, the network side device may not enable the main communication module).

In a case of indicating the at least one second network side device, the first signal may include ID information of the at least one second network side device, for example, a cell ID, a TRP ID, or an AP ID.

Optionally, to support sending of the first signal, the incident signal of the first signal is sent by the first network side device or the second network side device. For example, the incident signal is sent by the network side device through the ultra-low power module; or the incident signal of the first signal is sent by a third-party network device; or the incident signal is generated by the terminal.

Optionally, the terminal may deliver the first signal in the following cases:

If the incident signal is sent by the network side device, the terminal sends the first signal in the sending window (a continuous or discontinuous window) of the incident signal, where the sending window is notified to the terminal by the network-side device or protocol-agreed.

If the incident signal is sent by the terminal, the terminal may send the first signal at the random moment or send the first signal in the preset window.

If the sending time of the first signal generated by the terminal based on the incident signal exceeds one sending window of the incident signal, the terminal jointly sends the first signal by using a plurality of sending windows.

Optionally, the transmit power of the first signal may be as follows:
a fixed power for sending, where the fixed power is notified to the terminal by the network side device or protocol-specified.

The transmit power is determined based on an RSRP of a downlink reference

signal or a synchronization signal detected by the terminal. For example, the terminal determines the transmit power based on the RSRP and a preset formula, which is similar to an NR uplink power control formula. Associated parameters include PO, a compensation factor (alpha), and the like. The downlink reference signal may be sent by the network side device through the ultra-low power module.

The transmit power is determined based on an SINR/SNR value of the downlink reference signal detected by the terminal. For example, the terminal determines the transmit power through comparison between the SINR/SNR value of the reference signal and a preset target SINR/SNR value.

Step 2: The first network side device receives the first signal, and performs a related behavior based on an indication of the first signal, which may be specifically as follows:

After receiving the first signal through the ultra-low power module, the first network side device enables the main communication module (if the main communication module is previously disabled), and may transfer information indicated by the first signal to the main communication module.

If content indicated by the first signal involves a behavior of the second network side device, after receiving the first signal sent by the terminal, the first network side device forwards the content indicated by the first signal (in a wired or wireless manner) to the second network side device; and after receiving the indicated content, the second network side device performs the corresponding behavior.

Step 3: Before step 1, the terminal determines a parameter of the first signal according to a protocol specification or based on the received parameter configuration information of the first signal from the network side device, where the parameter of the first signal includes at least one of the following:
a time resource of the first signal;
a frequency resource of the first signal;
a signal waveform, a modulation scheme, or a coding scheme of the first signal;
a sequence generation related parameter of the first signal; and
a reflection coefficient or a transmit power of the first signal.

Sequence parameter information of the first signal (for example, an initialization sequence or a scrambling sequence) is associated with ID information of the first network side device.

In addition, the network side device may send the parameter configuration information of the first signal through the ultra-low power module or the main communication module.

Step 4: The terminal enables the main communication module, and performs one of the following target actions through the main communication module after a preset time window:
measuring the downlink reference signal;
receiving a downlink SSB, a SIB, or the like;
receiving a downlink paging signal; and
sending a preamble.

Alternatively, the terminal does not enable the main communication module, and performs one of the following target actions through the ultra-low power module after a preset time window:
measuring the downlink reference signal;
receiving a downlink SSB, a SIB, or the like;
receiving a downlink paging signal; and
sending a preamble.

The preset time window may be a time interval between sending the first signal by the terminal and performing the foregoing target action. The preset time window is related to a capability of the terminal. The preset time window may be configured by the network side device for the terminal, or is protocol-predefined.

### Embodiment 2

In this embodiment, the terminal indicates, through the ultra-low power module, the network side device to enter a target mode. A main difference between this embodiment and Embodiment 1 is that in Embodiment 2, the terminal may indicate the network side device to enter different target modes. These target modes are equivalent to sub-states in which the main communication module is enabled, which are specifically as follows:

Step 1: The terminal sends the first signal to the first network side device through the ultra-low power module, where the first signal indicates the first network side device to enter the target mode, and the target mode is one of a plurality of predefined modes.

Power consumption of the first network side device in a plurality of different modes may be different. For example, in a high power consumption mode, the first network side device may enable more transmit channels or receive channels, or use a higher transmit power; and in a low power consumption mode, the first network side device may enable fewer transmit channels or receive channels, or use a lower transmit power or a smaller quantity of SSBs.

A conversion time between different modes may be different. For example, a conversion time from a lowest power consumption mode to a highest power consumption mode is longest, and a conversion time between other states is relatively short.

For example, several different target modes are predefined as shown in Table 1 above. In both the first mode and the third mode, the network side device needs to enable the main communication module; and in the fourth mode, the network side device does not need to enable the main communication module, and only needs to enable the ultra-low power module.

In addition, the first signal may further indicate the second network side device to enter the target mode.

In this case, the first signal may include ID information of the at least one second network side device, for example, a cell ID, a TRP ID, or AP Information.

Optionally, to support sending of the first signal, the incident signal of the first signal is sent by the first network side device or the second network side device. For example, the incident signal is sent by the network side device through the ultra-low power module; or the incident signal of the first signal is sent by a third-party network device; or the incident signal is generated by the terminal.

Step 2: The first network side device receives the first signal, and enters the corresponding target mode based on an indication of the first signal, which may be specifically as follows:

After receiving the first signal through the ultra-low power module, the first network side device enables the main communication module (if the main communication module is previously disabled), and may transfer information indicated by the first signal to the main communication module.

If content indicated by the first signal involves a behavior of the second network side device, the first network side device sends the content indicated by the first signal (in a wired or wireless manner) to the second network side device; and then the second network side device enters the corresponding target mode.

Step 3: Before step 1, the terminal determines a parameter of the first signal according to a protocol specification or based on the received parameter configuration information of the first signal from the network side device, where the parameter of the first signal includes at least one of the following:
a time resource of the first signal;
a frequency resource of the first signal;
a modulation scheme and/or a coding scheme of the first signal;
a sequence generation related parameter of the first signal; and
a reflection coefficient or a transmit power of the first signal.

Sequence parameter information of the first signal (for example, an initialization sequence or a scrambling sequence) may be associated with ID information of the first network side device.

In addition, the network side device may send the parameter configuration information of the first signal through the ultra-low power module or the main communication module.

Step 4: The terminal enables the main communication module, and performs one of the following target actions through the main communication module after a preset time window:
measuring the downlink reference signal;
receiving a downlink SSB, a SIB, or the like;
receiving a downlink paging signal; and
sending a preamble.

Alternatively, the terminal does not enable the main communication module, and performs one of the following target actions through the ultra-low power module after a preset time window:
measuring the downlink reference signal;
receiving a downlink SSB, a SIB, or the like;
receiving a downlink paging signal; and
sending a preamble.

The preset time window may be a time interval between sending the first signal by the terminal and performing the foregoing target action. The preset time window is related to a capability of the terminal. The preset time window may be configured by the network side device for the terminal, or is protocol-predefined.

The signal sending method provided in embodiments of this application may be performed by a signal sending apparatus. In embodiments of this application, the signal sending apparatus provided in embodiments of this application is described by using an example in which the signal sending apparatus performs the signal sending method. The signal receiving method provided in embodiments of this application may be performed by a signal receiving apparatus. In embodiments of this application, the signal receiving apparatus provided in embodiments of this application is described by using an example in which the signal receiving apparatus performs the signal receiving method.

FIG. 6 is a structural diagram of a signal sending apparatus according to an embodiment of this application. As shown in FIG. 6, the signal sending apparatus 600 includes:
a sending module 601, configured to send a first signal to a first network side device through an ultra-low power module, where the first signal is used for at least one of the following: indicating to enable a main communication module, and indicating to enter a target communication mode;
the ultra-low power module is a module that supports ultra-low power communication;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Optionally, the ultra-low power communication includes at least one of the following:
backscatter communication and low power receiving.

Optionally, the ultra-low power module also supports energy harvesting.

Optionally, the indicating to enable a main communication module includes:

Optionally, the first signal is used for at least one of the following:
indicating the first network side device to enable the main communication module; and
indicating at least one second network side device to enable the main communication module.

Optionally, the indicating at least one second network side device to enable the main communication module includes:
indicating the at least one second network side device to enable the main communication module of a second frequency.

Optionally, in a case that the first signal indicates the at least one second network side device to enable the main communication module, the first signal includes: identification information of the at least one second network side device.

Optionally, the apparatus includes:
an execution module, configured to perform a target operation, where the target operation includes at least one of the following:
measuring a second signal sent by the first network side device;
measuring a second signal sent by the second network side device;
receiving a third signal sent by the first network side device;
receiving a third signal sent by the second network side device; and
sending a preamble.

Optionally, the second signal includes: a reference signal; and
the third signal includes at least one of the following:
a synchronization signal, system information, or a paging signal.

Optionally, the performing a target operation includes:
performing the target operation at a first time through the main communication module, where an interval between the first time and a sending time of the first signal is greater than or equal to first preset duration; or
performing the target operation at a second time through the ultra-low power module, where an interval between the second time and a sending time of the first signal is greater than or equal to second preset duration.

Optionally, an incident signal of the first signal is sent by the first network side device; or
an incident signal of the first signal is sent by the second network side device; or
an incident signal of the first signal is sent by a third-party device; or
an incident signal of the first signal is generated by the terminal.

Optionally, the sending module 601 is configured to perform at least one of the following:
in a case that the incident signal of the first signal is sent by the first network side device, the second network side device, or the third-party device, sending the first signal in a sending window of the incident signal through the ultra-low power module; or
in a case that the incident signal of the first signal is generated by the terminal, sending the first signal at a random moment or in a preset window through the ultra-low power module; or
in a case that the sending time of the first signal exceeds one sending window of the corresponding incident signal, jointly sending the first signal in a plurality of sending windows of the incident signal through the ultra-low power module, where the sending time of the first signal is generated based on the incident signal of the first signal.

Optionally, a transmit power for sending the first signal includes:
a fixed power; or
a transmit power determined based on a parameter of a downlink signal detected by the terminal, where
the parameter includes at least one of the following:
a reference signal received power RSRP, a signal to interference plus noise ratio SINR, and a signal-to-noise ratio SNR; and
the transmit power determined based on the parameter of the downlink signal detected by the terminal includes:
a transmit power determined based on the RSRP of the downlink signal detected by the terminal and a preset formula; or
a transmit power determined based on the SINR of the downlink signal detected by the terminal and a preset SINR; or
a transmit power determined based on the SNR of the downlink signal detected by the terminal and a preset SNR.

Optionally, the downlink signal includes at least one of the following:
a downlink reference signal and a synchronization signal.

Optionally, the apparatus further includes:
a first determining module, configured to determine parameter configuration information of the first signal according to a protocol specification; or
a second determining module, configured to determine parameter configuration information of the first signal based on configuration information sent by a network side, where
the parameter configuration information includes at least one of the following:
a time resource, a frequency resource, a signal waveform, a modulation scheme, a coding scheme, a sequence generation parameter, a reflection coefficient, and a transmit power.

Optionally, the sequence generation parameter is associated with identification information of the first network side device.

Optionally, the first signal is used for at least one of the following:
indicating the first network side device to enter the target communication mode; and
indicating the at least one second network side device to enter the target communication mode.

Optionally, in a case that the first signal indicates the at least one second network side device to enter the target communication mode, the first signal includes: identification information of the at least one second network side device.

Optionally, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

Optionally, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module.

The signal sending apparatus may save power consumption of the terminal and the network side device.

The signal sending apparatus in this embodiment of this application may be an electronic device, for example, an electronic device with an operating system, or may be a component in the electronic device, for example, an integrated circuit or a chip. For example, the electronic device may be a terminal, or another device that is not the terminal. For example, the terminal may include but is not limited to the types of the terminal listed in this embodiment of this application, and the another device may be a server, a network attached storage (Network Attached Storage, NAS), or the like. This is not specifically limited in this embodiment of this application.

The signal sending apparatus provided in this embodiment of this application can implement the processes implemented in the method embodiment shown in FIG. 4, and same technical effect can be achieved. To avoid repetition, details are not described herein again.

FIG. 7 is a structural diagram of a signal receiving apparatus according to an embodiment of this application. As shown in FIG. 7, the signal receiving apparatus 700 includes:
a first receiving module 701, configured to receive a first signal sent by a terminal, where the first signal is used for at least one of the following: indicating to enable a main communication module, and indicating to enter a target communication mode;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Optionally, the apparatus further includes:
an execution module, configured to perform a target operation based on the first signal, where the target operation includes at least one of the following: enabling the main communication module, and entering the target communication mode.

Optionally, the indicating to enable a main communication module includes:
indicating to enable the main communication module of a first frequency.

Optionally, the first signal is used for at least one of the following:
indicating the first network side device to enable the main communication module; and
indicating at least one second network side device to enable the main communication module; and
in a case that the first signal indicates the at least one second network side device to enable the main communication module, the method further includes:
the first network side device sends indication information of the first signal to the at least one network side device, where the indication information is used to indicate the at least one second network side device to enable the main communication module.

Optionally, the indicating at least one second network side device to enable the main communication module includes:
indicating the at least one second network side device to enable the main communication module of a second frequency.

Optionally, in a case that the first signal indicates the at least one second network side device to enable the main communication module, the first signal includes: identification information of the at least one second network side device.

Optionally, the apparatus further includes at least one of the following:
a first sending module, configured to send a second signal to the terminal through an ultra-low power module, where the ultra-low power module is a module that supports ultra-low power communication;
a second sending module, configured to send a third signal to the terminal through the main communication module; and
a second receiving module, configured to receive a preamble sent by the terminal.

Optionally, the second signal includes: a reference signal; and
the third signal includes at least one of the following:
a synchronization signal, system information, or a paging signal.

Optionally, the apparatus further includes:
a third sending module, configured to send an incident signal of the first signal to the terminal.

Optionally, the first receiving module 701 is configured to receive, in a sending window of the incident signal, the first signal sent by the terminal.

Optionally, the apparatus further includes:
a fourth sending module, configured to send configuration information to the terminal, where the configuration information is used to determine parameter configuration information of the first signal; and
the parameter configuration information includes at least one of the following:
a time resource, a frequency resource, a signal waveform, a modulation scheme, a coding scheme, a sequence generation parameter, a reflection coefficient, and a transmit power.

Optionally, the sequence generation parameter is associated with identification information of the first network side device.

Optionally, the first signal is used for at least one of the following:
indicating the first network side device to enter the target communication mode; and
indicating the at least one second network side device to enter the target communication mode; and
in a case that the first signal indicates the at least one second network side device to enter the target communication mode, the method further includes:
the first network side device sends indication information of the first signal to the at least one network side device, where the indication information is used to indicate the at least one second network side device to enter the target communication mode.

Optionally, in a case that the first signal indicates the at least one second network side device to enter the target communication mode, the first signal includes: identification information of the at least one second network side device.

Optionally, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

Optionally, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module, where the ultra-low power module is a module that supports ultra-low power communication.

The signal receiving apparatus may save power consumption of the terminal and the network side device.

The signal receiving apparatus in this embodiment of this application may be an electronic device, for example, an electronic device with an operating system, or may be a component in the electronic device, for example, an integrated circuit or a chip. The electronic device may be a terminal or a network side device.

The signal receiving apparatus provided in this embodiment of this application can implement the processes implemented in the method embodiment shown in FIG. 5, and same technical effect can be achieved. To avoid repetition, details are not described herein again.

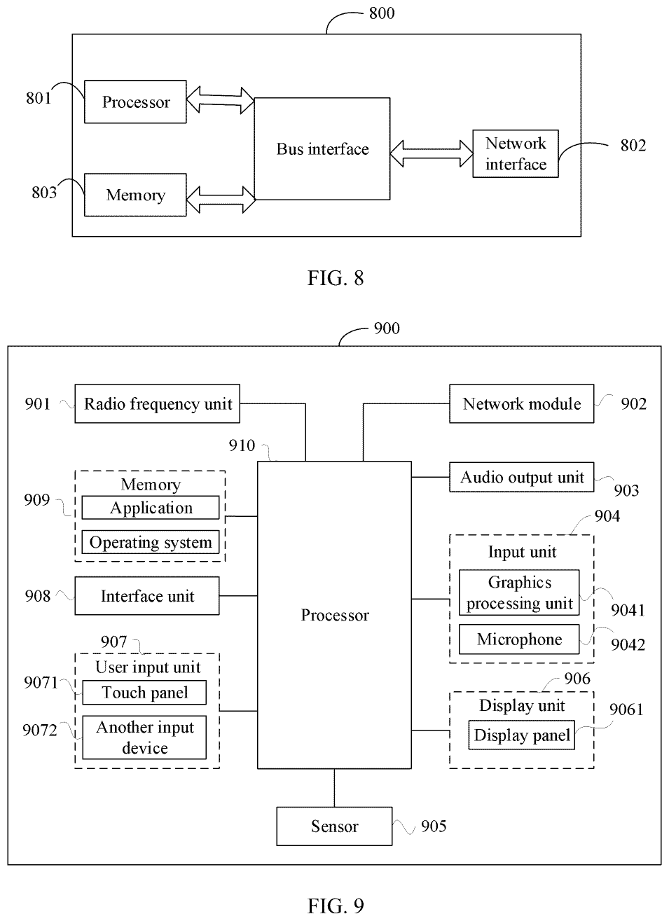

Optionally, as shown in FIG. 8, an embodiment of this application further provides a communication device 800. The communication device 800 includes a processor 801 and a memory 802, and the memory 802 stores a program or an instruction that can be run on the processor 801. For example, when the communication device 800 is a terminal, and the program or the instruction is executed by the processor 801, steps of the foregoing signal sending method embodiment are implemented, and same technical effect can be achieved.

When the communication device 800 is a network side device, and the program or the instruction is executed by the processor 801, steps of the foregoing signal receiving method embodiment are implemented, and same technical effect can be achieved. To avoid repetition, details are not described herein again.

An embodiment of this application further provides a terminal. The terminal includes a processor and a communication interface. The communication interface is configured to send a first signal to a first network side device through an ultra-low power module, where the first signal is used for at least one of the following: indicating to enable a main communication module, and indicating to enter a target communication mode; the ultra-low power module is a module that supports ultra-low power communication; the target communication mode includes one of the following: a first mode, a second mode, a third mode, and a fourth mode; and a power consumption level of the first mode is higher than a power consumption level of the second mode, the power consumption level of the second mode is higher than a power consumption level of the third mode, and the power consumption level of the third mode is higher than a power consumption level of the fourth mode. The terminal embodiment corresponds to the foregoing method embodiment on the terminal side, each implementation process and implementation of the foregoing method embodiment can be applied to the terminal embodiment, and same technical effect can be achieved. Specifically, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The structure of the terminal shown in FIG. 9 does not constitute a limitation on the terminal. The terminal may include more or fewer components than those shown in the figure, or combine some components, or have different component arrangements. Details are not described herein.

It should be understood that in this embodiment of this application, the input unit 904 may include a graphics processing unit (Graphics Processing Unit, GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, and the like. The modem processor mainly processes a wireless communication signal, for example, a baseband processor. It may be understood that, alternatively, the modem processor may not be integrated into the processor 910.

The radio frequency unit 901 is configured to send a first signal to a first network side device through an ultra-low power module, where the first signal is used for at least one of the following: indicating to enable a main communication module, and indicating to enter a target communication mode;
the ultra-low power module is a module that supports ultra-low power communication;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Optionally, the ultra-low power communication includes at least one of the following:
backscatter communication and low power receiving.

Optionally, the ultra-low power module also supports energy harvesting.

Optionally, the indicating to enable a main communication module includes:
indicating to enable the main communication module of a first frequency.

Optionally, the first signal is used for at least one of the following:
indicating the first network side device to enable the main communication module; and
indicating at least one second network side device to enable the main communication module.

Optionally, the indicating at least one second network side device to enable the main communication module includes:
indicating the at least one second network side device to enable the main communication module of a second frequency.

Optionally, in a case that the first signal indicates the at least one second network side device to enable the main communication module, the first signal includes: identification information of the at least one second network side device.

Optionally, after the terminal sends the first signal to the first network side device through the ultra-low power module, the radio frequency unit 901 is further configured to:
perform a target operation, where the target operation includes at least one of the following:
measuring a second signal sent by the first network side device;
measuring a second signal sent by the second network side device;
receiving a third signal sent by the first network side device;
receiving a third signal sent by the second network side device; and
sending a preamble.

Optionally, the second signal includes: a reference signal; and
the third signal includes at least one of the following:
a synchronization signal, system information, or a paging signal.

Optionally, that the radio frequency unit 901 performs a target operation includes:

The radio frequency unit 901 performs the target operation at a first time through the main communication module, where an interval between the first time and a sending time of the first signal is greater than or equal to first preset duration; or
the radio frequency unit 901 performs the target operation at a second time through the ultra-low power module, where an interval between the second time and a sending time of the first signal is greater than or equal to second preset duration.

Optionally, an incident signal of the first signal is sent by the first network side device; or
an incident signal of the first signal is sent by the second network side device; or
an incident signal of the first signal is sent by a third-party device; or
an incident signal of the first signal is generated by the terminal.

Optionally, the sending a first signal to a first network side device through an ultra-low power module includes at least one of the following:
in a case that the incident signal of the first signal is sent by the first network side device, the second network side device, or the third-party device, sending the first signal in a sending window of the incident signal through the ultra-low power module; or
in a case that the incident signal of the first signal is generated by the terminal, sending the first signal at a random moment or in a preset window through the ultra-low power module; or
in a case that the sending time of the first signal exceeds one sending window of the corresponding incident signal, jointly sending the first signal in a plurality of sending windows of the incident signal through the ultra-low power module, where the sending time of the first signal is generated based on the incident signal of the first signal.

Optionally, a transmit power of the first signal sent by the terminal includes:
a fixed power; or
a transmit power determined based on a parameter of a downlink signal detected by the terminal, where
the parameter includes at least one of the following:
a reference signal received power RSRP, a signal to interference plus noise ratio SINR, and a signal-to-noise ratio SNR; and
the transmit power determined based on the parameter of the downlink signal detected by the terminal includes:
a transmit power determined based on the RSRP of the downlink signal detected by the terminal and a preset formula; or
a transmit power determined based on the SINR of the downlink signal detected by the terminal and a preset SINR; or
a transmit power determined based on the SNR of the downlink signal detected by the terminal and a preset SNR.

Optionally, the downlink signal includes at least one of the following:
a downlink reference signal and a synchronization signal.

Optionally, before the terminal sends the first signal to the first network side device through the ultra-low power module, the processor 910 is configured to:
determine parameter configuration information of the first signal according to a protocol specification; or
determine parameter configuration information of the first signal based on configuration information sent by a network side, where
the parameter configuration information includes at least one of the following:
a time resource, a frequency resource, a signal waveform, a modulation scheme, a coding scheme, a sequence generation parameter, a reflection coefficient, and a transmit power.

Optionally, the sequence generation parameter is associated with identification information of the first network side device.

Optionally, the first signal is used for at least one of the following:
indicating the first network side device to enter the target communication mode; and
indicating the at least one second network side device to enter the target communication mode.

Optionally, in a case that the first signal indicates the at least one second network side device to enter the target communication mode, the first signal includes: identification information of the at least one second network side device.

Optionally, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

Optionally, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module.

The terminal may save power consumption of the terminal and the network side device.

An embodiment of this application further provides a network side device. The network side device includes a processor and a communication interface. The communication interface is configured to receive a first signal sent by a terminal, where the first signal is used for at least one of the following: indicating to enable a main communication module, and indicating to enter a target communication mode; the target communication mode includes one of the following: a first mode, a second mode, a third mode, and a fourth mode; and a power consumption level of the first mode is higher than a power consumption level of the second mode, the power consumption level of the second mode is higher than a power consumption level of the third mode, and the power consumption level of the third mode is higher than a power consumption level of the fourth mode. The network side device embodiment corresponds to the method embodiment of the network side device, each implementation process and implementation of the method embodiment can be applied to the network side device embodiment, and same technical effect can be achieved.

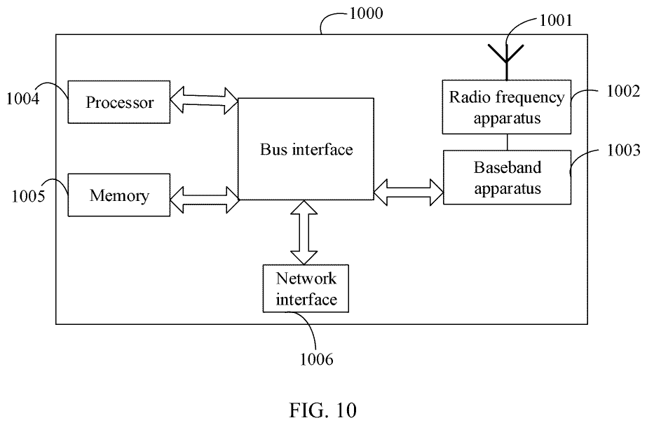

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 through a bus interface, to invoke a program in the memory 1005 to perform the operations of the network side device shown in the method embodiment.

The network side device may further include a network interface 1006, and the interface is, for example, a common public radio interface (common public radio interface, CPRI).

Specifically, the network side device 1000 in this embodiment of this application further includes an instruction or a program that is stored in the memory 1005 and that can be run on the processor 1004. The processor 1004 invokes the instruction or the program in the memory 1005 to execute the method executed by the modules shown in FIG. 7, and same technical effect is achieved. To avoid repetition, details are not described herein again.

The radio frequency apparatus 1002 is configured to receive a first signal sent by a terminal, where the first signal is used for at least one of the following: indicating to enable a main communication module, and indicating to enter a target communication mode;
the target communication mode includes one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

Optionally, the processor 1004 is configured to:
perform a target operation based on the first signal, where the target operation includes at least one of the following: enabling the main communication module, and entering the target communication mode.

Optionally, the indicating to enable a main communication module includes:
indicating to enable the main communication module of a first frequency.

Optionally, the first signal is used for at least one of the following:
indicating the first network side device to enable the main communication module; and
indicating at least one second network side device to enable the main communication module; and
in a case that the first signal indicates the at least one second network side device to enable the main communication module, the method further includes:
the first network side device sends indication information of the first signal to the at least one network side device, where the indication information is used to indicate the at least one second network side device to enable the main communication module.

Optionally, the indicating at least one second network side device to enable the main communication module includes:
indicating the at least one second network side device to enable the main communication module of a second frequency.

Optionally, in a case that the first signal indicates the at least one second network side device to enable the main communication module, the first signal includes: identification information of the at least one second network side device.

Optionally, after receiving the first signal sent by the terminal, the radio frequency apparatus 1002 is further configured to:
send a second signal to the terminal through an ultra-low power module, where the ultra-low power module is a module that supports ultra-low power communication;
send a third signal to the terminal through the main communication module; and
receive a preamble sent by the terminal.

Optionally, the second signal includes: a reference signal; and
the third signal includes at least one of the following:
a synchronization signal, system information, or a paging signal.

Optionally, before receiving the first signal sent by the terminal, the radio frequency apparatus 1002 is further configured to:
send an incident signal of the first signal to the terminal.

Optionally, the receiving a first signal sent by a terminal includes:
receiving, in a sending window of the incident signal, the first signal sent by the terminal.

Optionally, before receiving the first signal sent by the terminal, the radio frequency apparatus 1002 is further configured to:
send configuration information to the terminal, where the configuration information is used to determine parameter configuration information of the first signal; and
the parameter configuration information includes at least one of the following:
a time resource, a frequency resource, a signal waveform, a modulation scheme, a coding scheme, a sequence generation parameter, a reflection coefficient, and a transmit power.

Optionally, the sequence generation parameter is associated with identification information of the first network side device.

Optionally, the first signal is used for at least one of the following:
indicating the first network side device to enter the target communication mode; and
indicating the at least one second network side device to enter the target communication mode; and
in a case that the first signal indicates the at least one second network side device to enter the target communication mode, the radio frequency apparatus 1002 is further configured to:
send indication information of the first signal to the at least one network side device, where the indication information is used to indicate the at least one second network side device to enter the target communication mode.

Optionally, in a case that the first signal indicates the at least one second network side device to enter the target communication mode, the first signal includes: identification information of the at least one second network side device.

Optionally, a quantity of transmit channels in the first mode is greater than a quantity of transmit channels in the second mode, the quantity of transmit channels in the second mode is greater than a quantity of transmit channels in the third mode, and the quantity of transmit channels in the third mode is greater than a quantity of transmit channels in the fourth mode; or
a quantity of receive channels in the first mode is greater than a quantity of receive channels in the second mode, the quantity of receive channels in the second mode is greater than a quantity of receive channels in the third mode, and the quantity of receive channels in the third mode is greater than a quantity of receive channels in the fourth mode; or
a quantity of synchronization signal blocks in the first mode is greater than a quantity of synchronization signal blocks in the second mode, the quantity of synchronization signal blocks in the second mode is greater than a quantity of synchronization signal blocks in the third mode, and the quantity of synchronization signal blocks in the third mode is greater than a quantity of synchronization signal blocks in the fourth mode.

Optionally, in the first mode, the second mode, and the third mode, the network side device enables the main communication module; and in the fourth mode, the network side device disables the main communication module; or
in the first mode, the second mode, and the third mode, the network side device enables or disables the ultra-low power module; and in the fourth mode, the network side device enables the ultra-low power module, where the ultra-low power module is a module that supports ultra-low power communication.

The network side device may save power consumption of the terminal and the network side device.

An embodiment of this application further provides a readable storage medium. The readable storage medium stores a program or an instruction; and when the program or the instruction is executed by a processor, the processes of the foregoing embodiment of the signal sending method or the signal receiving method, and same technical effect can be achieved. To avoid repetition, details are not described herein again.

The processor is a processor in the terminal in the foregoing embodiments. The readable storage medium includes a computer-readable storage medium such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor, the processor is configured to run a program or an instruction to implement the processes of the foregoing embodiment of the signal sending method or the signal receiving method, and same technical effect can be achieved. To avoid repetition, details are not described herein again.

It should be understood that the chip mentioned in this embodiment of this application may also be referred to as a system-level chip, a system chip, a chip system, or a system-on-a-chip chip.

An embodiment of this application further provides a computer program/program product. The computer program/program product is stored in a storage medium, the computer program/program product is executed by at least one processor to implement the processes of the foregoing embodiment of the signal sending method or the signal receiving method, and same technical effect can be achieved. To avoid repetition, details are not described herein again.

An embodiment of this application further provides a signal transmission system. The signal transmission system includes a terminal and a network side device. The terminal may be configured to perform steps of the signal sending method according to embodiments of this application, and the network side device may be configured to perform steps of the signal receiving method according to embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in embodiments of this application is not limited to performing functions in the order illustrated or discussed, and may also include performing functions in a basically simultaneous manner or in an opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or certainly may be implemented by hardware. The computer software product is stored in a storage medium (such as a ROM, a RAM, a magnetic disk, or an optical disc), and includes several instructions for instructing a terminal or a network side device to perform the methods described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of the implementations fall within the protection of this application.

1. A signal sending method, comprising:
sending, by a terminal, a first signal to a first network side device through an ultra-low power module, wherein the first signal is used for at least one of the following: indicating to enable a main communication module, or indicating to enter a target communication mode;
the ultra-low power module is a module that supports ultra-low power communication;
the target communication mode comprises one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

2. The method according to claim 1, wherein the ultra-low power communication comprises at least one of the following:
backscatter communication or low power receiving.

3. The method according to claim 1, wherein the ultra-low power module further supports energy harvesting.

4. The method according to claim 1, wherein the indicating to enable a main communication module comprises:
indicating to enable the main communication module of a first frequency.

5. The method according to claim 1, wherein the first signal is used for at least one of the following:
indicating the first network side device to enable the main communication module; or
indicating at least one second network side device to enable the main communication module.

6. The method according to claim 5, wherein the indicating at least one second network side device to enable the main communication module comprises:
indicating the at least one second network side device to enable the main communication module of a second frequency.

7. The method according to claim 5, wherein in a case that the first signal indicates the at least one second network side device to enable the main communication module, the first signal comprises: identification information of the at least one second network side device.

8. The method according to claim 1, wherein after the sending, by a terminal, a first signal to a first network side device through an ultra-low power module, the method further comprises:
performing, by the terminal, a target operation, wherein the target operation comprises at least one of the following:
measuring a second signal sent by the first network side device;
measuring a second signal sent by the second network side device;
receiving a third signal sent by the first network side device;
receiving a third signal sent by the second network side device; or sending a preamble.

9. The method according to claim 8, wherein the second signal comprises a reference signal; and
the third signal comprises at least one of the following:
a synchronization signal, system information, or a paging signal.

10. The method according to claim 8, wherein the performing, by the terminal, a target operation comprises:
performing, by the terminal, the target operation at a first time through the main communication module, wherein an interval between the first time and a sending time of the first signal is greater than or equal to first preset duration; or
performing, by the terminal, the target operation at a second time through the ultra-low power module, wherein an interval between the second time and a sending time of the first signal is greater than or equal to second preset duration.

11. The method according to claim 1, wherein an incident signal of the first signal is sent by the first network side device; or
an incident signal of the first signal is sent by the second network side device; or
an incident signal of the first signal is sent by a third-party device; or
an incident signal of the first signal is generated by the terminal.

12. The method according to claim 11, wherein the sending, by a terminal, a first signal to a first network side device through an ultra-low power module comprises at least one of the following:
in a case that the incident signal of the first signal is sent by the first network side device, the second network side device, or the third-party device, sending, by the terminal, the first signal in a sending window of the incident signal through the ultra-low power module; or
in a case that the incident signal of the first signal is generated by the terminal, sending, by the terminal, the first signal at a random moment or in a preset window through the ultra-low power module; or
in a case that the sending time of the first signal exceeds one sending window of the corresponding incident signal, jointly sending, by the terminal, the first signal in a plurality of sending windows of the incident signal through the ultra-low power module, wherein the sending time of the first signal is generated based on the incident signal of the first signal.

13. The method according to claim 1, wherein a transmit power of the first signal sent by the terminal comprises:
a fixed power; or
a transmit power determined based on a parameter of a downlink signal detected by the terminal, wherein
the parameter comprises at least one of the following:
a reference signal received power RSRP, a signal to interference plus noise ratio SINR, or a signal-to-noise ratio SNR; and
the transmit power determined based on the parameter of the downlink signal detected by the terminal comprises:
a transmit power determined based on the RSRP of the downlink signal detected by the terminal and a preset formula; or
a transmit power determined based on the SINR of the downlink signal detected by the terminal and a preset SINR; or
a transmit power determined based on the SNR of the downlink signal detected by the terminal and a preset SNR.

14. The method according to claim 13, wherein the downlink signal comprises at least one of the following:
a downlink reference signal or a synchronization signal.

15. The method according to claim 1, wherein before the sending, by a terminal, a first signal to a first network side device through an ultra-low power module, the method further comprises:
determining, by the terminal, parameter configuration information of the first signal according to a protocol specification; or
determining, by the terminal, parameter configuration information of the first signal based on configuration information sent by a network side, wherein
the parameter configuration information comprises at least one of the following:
a time resource, a frequency resource, a signal waveform, a modulation scheme, a coding scheme, a sequence generation parameter, a reflection coefficient, or a transmit power.

16. The method according to claim 15, wherein the sequence generation parameter is associated with identification information of the first network side device.

17. A signal receiving method, comprising:
receiving, by a first network side device, a first signal sent by a terminal, wherein the first signal is used for at least one of the following: indicating to enable a main communication module, or indicating to enter a target communication mode;
the target communication mode comprises one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

18. The method according to claim 17, further comprising:
performing, by the first network side device, a target operation based on the first signal, wherein the target operation comprises at least one of the following: enabling the main communication module, or entering the target communication mode.

19. A terminal, comprising a processor and a memory, wherein the memory stores a program or an instruction that can be run on the processor, and the program or the instruction is executed by the processor to implement a signal sending method comprising:
sending a first signal to a first network side device through an ultra-low power module, wherein the first signal is used for at least one of the following: indicating to enable a main communication module, or indicating to enter a target communication mode;
the ultra-low power module is a module that supports ultra-low power communication;
the target communication mode comprises one of the following:
a first mode, a second mode, a third mode, and a fourth mode; and
a power consumption level of the first mode is higher than a power consumption level of the second mode, the power consumption level of the second mode is higher than a power consumption level of the third mode, and the power consumption level of the third mode is higher than a power consumption level of the fourth mode.

20. A network side device, comprising a processor and a memory, wherein the memory stores a program or an instruction that can be run on the processor, and the program or the instruction is executed by the processor to implement steps of the signal receiving method according to claim 17.
